(19) United States
(12) Patent Application Publication
(10) Pub. No.: US 2023/0031587 A1
(43) Pub. Date: Feb. 2, 2023

(54) SYSTEM AND METHOD OF CONTROLLING IMAGE PROCESSING DEVICES

(71) Applicant: DEVAR ENTERTAINMENT LIMITED, NICOSIA (CY)

(72) Inventors: Andrei Valerievich KOMISSAROV, Tula (RU); Anna Igorevna BELOVA, Tula (RU)

(21) Appl. No.: 17/959,488

(22) Filed: Oct. 4, 2022

Related U.S. Application Data
(63) Continuation-in-part of application No. 16/882,619, filed on May 25, 2020, now abandoned.
Application No. 16/882,619 is a continuation-in-part of application No. 15/758,379, filed on Mar. 8, 2018, now abandoned.

(30) Foreign Application Priority Data
Sep. 24, 2015 (RU) 2015140595

(51) Int. Cl. G06T 19/00

(52) U.S. Cl. CPC G06T 19/006

(57) ABSTRACT

The present application provides a system for creating and displaying AR scenes by mobile devices. The system includes a plurality of mobile devices that are used by either registered or unregistered users and provides registration capabilities for users. It allows the devices to use server-side processing for creating and editing of AR scenes. The server capabilities are accessed from the user devices via a browser. This system includes a server part which includes an authentication module, an AR scene editor, a library of 3D models, a catalog of ready-made AR scenes, multiple personal catalogs AR scenes, associated to registered users of the system, multiple personal content libraries associated to the registered users, a library of algorithms for recognition objects and the surrounding space or environment, The system can be managed to allow access to the catalog of ready-made AR scenes to any users or only to registered users.

### CROSS-REFERENCE TO RELATED APPLICATIONS

This patent application is a Continuation-in-part of the U.S. patent application Ser. No. 16/882,619 filed on May 25, 2020, which is a Continuation-in-part of the U.S. patent application Ser. No. 15/758,379 filed on Mar. 8, 2018, which is a National stage application from PCT application PCT/RU2016/050031 filed on Sep. 9, 2016, which claims priority to Russian patent application RU 2015140595 filed on Sep. 24, 2015, all of which are incorporated herein by references in their entirety.

### FIELD OF INVENTION

The invention relates to the field of information technology, computer technology, namely, processing and generating image data, image processing for computer graphics, and can be used to search, retrieve and process and display image data.

### BACKGROUND

A known method for capturing an image comprises the following steps: capturing a digital image; receiving the image capture position information indicating the position in which the digital image is captured; receive direction information of the image grip indicating the direction in which the digital image is captured; receiving direction information of the image grip indicating the direction in which the digital image is captured; receiving a plurality of additional information elements from the additional information storage device that stores a plurality of additional information elements, wherein each element of the plurality of supplementary information elements corresponds to a predetermined object, and each element contains object position information indicating the position of the corresponding object; determining view space by the image pickup position information and the image acquisition direction information divided into subfields and selected for each of the subfields corresponding one or more additional information elements having an amount not exceeding an amount that is set in the corresponding one of the subfields among the plurality of elements up to additional information containing a plurality of item information items of objects, respectively indicating the positions contained in the subfields; and displaying the corresponding one or more elements from the plurality of supplementary information elements overlaid on the digital image, wherein the corresponding one or more elements from the plurality of supplementary information items are selected in said selection step (see. RU 2463663 C2, cl. G06T19/00, G06T11/60).

The known method can be implemented to visualize and filter additional landmark information superimposed on a terrain image captured by a camera.

The disadvantage of the known method is its limited application only in the mapping of the landmarks of the terrain and that it requires obtaining data on the direction and position of the capture. The known method can not be used to display additional information about movable objects or objects not tied to the terrain. These drawbacks limit the scope of application of the known method.

The closest in technical essence, the prototype, is a method for managing an image processing device capable of communicating with a server that provides a microblogging function for publishing a message registered by a user to another user and including a data storage unit configured to store image data. The method comprises the steps of:

registering with the registration unit the first message on the server, if the image data is stored in the data storage unit;

tracking the second message by the tracking unit, which re-registered with respect to the first message registered at the time of registration;

analyzing the second message by the analysis unit if the second message is detected during the tracking; and

storing the image data in the data storage unit is transmitted by the transmission unit based on the analysis result at the time of analysis (see RU 2013158163 A, cl. G06F13/00).

The known solution allows to provide additional information to the image and provide it to another user.

The disadvantage of the known method is the excessive accumulation of additional information related to the image, regardless of the circumstances of capturing the image, leading to the use of high requirements for capacity and speed of storage of digital information and excluding or making it difficult to apply additional information as required due to the need to select information from a large information volume.

A known solution provides for the exchange of messages regarding an image that is static image or an image obtained in the past. This image can not be an image obtained in real time.

In addition, the essence of the known solution is reduced to the exchange of messages with the user, that is, there is an address communication that requires an addressee, which is not acceptable in the presence of a large number of potential recipients.

### SUMMARY

The technical results achieved herein are:
simplification of the implementation by reducing the requirements for the wireless communication lines employed,
improvement in ease of use by excluding the possibility of display additional information not related to objects in the image,
ensuring the capability of using an image obtained in real time with augmented reality (AR),
providing the capability of obtaining additional information for an unlimited number of users,
providing the possibility for a user to create own, clone or modify existing AR scenes and making them accessible to other users,
providing an ability to create personal catalogs of AR scenes on the server for registered users,
providing the widest range of user devices suitable for creating and displaying the AR scenes and reduce the threshold of entry due to the absence of the need to install additional software;
isolated execution of the recognition algorithm code inside the Wasm virtual machine ensures the security of user data and the stability of his device

The invention is further explained and illustrated with the drawings, wherein

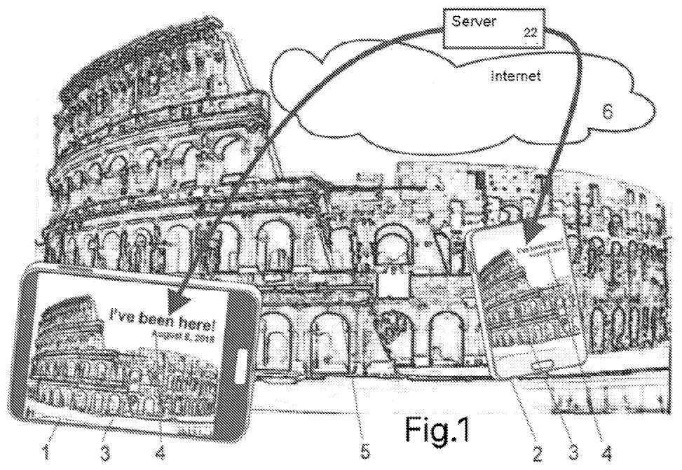

FIG. 1 is a schematic representation of an implementation of a method for controlling an image processing apparatus;

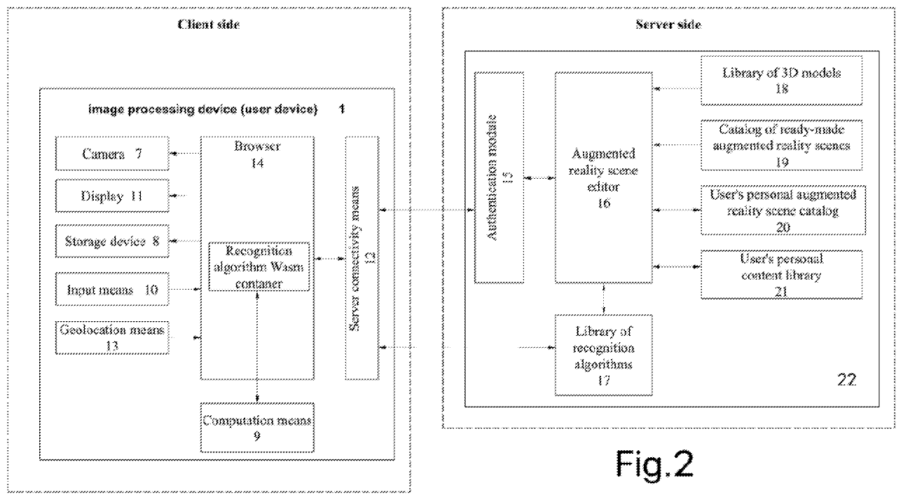

FIG. 2 is a block diagram of the system for controlling communication devices.

The following notations are made in the drawings.

1—image processing device (user device), 2—image processing device of another registered user, 3—object detected and recognized on the image, 4—image of additional information, 5—architectural object, 6—Internet, 7—built-in camera, 8—digital storage device of the image processing device, 9—computation means, 10—input means, 11—display (screen), 12—module for communication with the server, 13—geolocation module, 14—browser, 15—authentication module, 16—augmented reality scene editor, 17—library of recognition algorithms, 18—library of 3D models, 19—catalog of ready-made augmented reality scenes, 20—user's personal augmented reality scene catalog, 21—user's personal content library, 22—server.

### DETAILED DESCRIPTION OF THE PREFERRED EMBODIMENT

The method for controlling the image processing apparatus is provided as follows. The description of the method is related to the need to define the following terms: The resulting image—the image signal obtained from the camera output or from the digital drive memory. Additional information—data of text, image, sound, 3D models, video recordings or their combinations that may be inputted by the user input means and displayed by the user device on top of the resulting image. Geolocation data—the geographical coordinates of the image processing device, obtained with the help of GPS, GLONASS, GSM base stations or similar.

Data regarding the image received—data related to the detected and recognized object on the resulting image, as well as geolocation data of the place where the image processing device received the image and entered additional information. Recognized object is an object of the real world, localized on the resulting image by image recognition algorithms, said recognized object is being used as a marker for displaying the additional information. A scene of AR scene comprises additional information each component of which (data of text, image, sound, 3D models) placed and oriented in three-dimensional space in relation to the recognized object. Registered users—members of the Internet resource of social, educational, professional or other orientation registered according to the order established for such a resource and having an ability to generate and publish additional information associated with the resulting image using their image processing devices. Publication of the additional information related to the AR scene—the transfer of corresponding signals to data processing facilities on a server that provides access for registered users through their image processing devices to additional information related to the AR scene. Displaying the AR scene over the resulting image—the formation of a single data block displayed on the screen and/or reproduced by the playback means when referring to the corresponding image of the object detected on the image. Server-based data processing tools are a remote server or a set of servers connected to each other and implementing one of the cloud technology models, such as, for example, SaaS, PaaS, IaaS, Utility computing, MSP. AR scene editor is a 3D vector editor located in the backend (server side) that allows user to create a digital twin of a recognized object, associate additional information with it, position and orient it in 3D space. The user's personal content library is a private storage of additional information of a registered user used by him to create AR scenes. User's personal catalog of AR scenes is a private repository of AR scenes created by him as a registered user with the ability to provide access to it to other registered users. Catalog of ready-made AR scenes is a repository of AR scenes with open access for all registered users. Publication of an AR scene means providing general access of users to an AR scene by creating and distributing a URL link or a QR code on the Internet (registration is not required). Publishing geolocation of an AR scene means associating a scene with geographic coordinates to allow registered users to search for nearby scenes. Each registered user preliminarily transmits his identification data to the server processing facilities, thereby presenting these data to the resource administrator, said identification data being registered when creating a new registered user.

The first registered user gets access to the server part of the system from the first user device, using a browser he prepares or publishes an AR scene by performing the following actions:
creating a new or importing a ready-made AR scene, which is publicly available in the catalog of ready-made AR scenes on the server;
amending scene by filling the scene using 3D model library objects and user's personal content (images, videos, text, sounds, own 3D models), which are stored in the user's personal content library and available for reuse;
saving the amended scene in the user's personal catalog of AR scenes and publishing it for display on devices of other users;
publishing of the amended AR scene and transferring the URL link to the second user's device by sending a text message or a QR code

Access to AR scenes created by users may be differentiated. For example, the second registered user can search for nearby AR scenes close to his current location. The third unregistered user is able to access AR scenes only by entering the corresponding URL links in the address bar of the user's device browser (or by scanning a QR code).

In response to a user request by the scene URL, the server part sends to the user's device a Wasm, or WebAssembly, container containing the implementation of the recognition algorithm basic for the loaded scene of AR and executed in the browser directly on the user's device.

With the built-in camera or digital storage, an image signal is generated and translated onto the screen of the image processing apparatus to display it in real time and feeding it to the calculation means of the Wasm-container based image processing algorithm.

With the help of the calculation tools, the image received from the camera is compared with the recognized object's digital twin stored in the memory of the image processing device, and, if necessary, receive geolocation data using the built-in geolocation module.

Providing the registered user with the ability to enter additional information regarding the recognized object on the image received from the camera and displayed on the screen. In this case, additional information can be textual entered using the real or virtual (screen) keyboard of the image processing device or an image or video record created or selected from the archive, or an audio file created using the microphone of the registered user device or selected from the archive or a 3D model selected from the library or combination of the above.

In the event that an object is detected on the resulting image, the registered user is prompted to enter additional information and associate it with the recognized object and its AR scene to form a single data block. This single data block includes, if necessary, geolocation data of the place where the object was recognized.

Transmitting by the image processing device communication means for communicating with the server additional information associated with recognized object and its AR scene to the personal user content library, with the capability of sharing this information with other registered users.

Obtaining from the sever available additional information associated recognized object and its AR scene by other registered users.

Displaying or reproducing the AR scene and the additional information received from the server related to image on which the object was recognized.

Additional information is formed in the form of text and/or image and/or sound and/or a combination thereof.

The image processing apparatus comprises a built-in camera or digital storage device wherein previously saved images are stored, input means provided as keyboard and/or built-in microphone buttons, computing means, digital storage, geolocation module, display and sound reproduction module.

The augmented reality server includes an authentication module, an AR scene editor, a library of 3D models, a catalog of ready-made AR scenes, a user's personal AR scene catalog, a user's personal content library; a library of recognition algorithms.

The display of additional information introduced earlier with the aid of other image processing devices is carried out on top of the received image, and the reproduction of the audio additional information is carried out in priority order.

The method for controlling the image processing apparatus is implemented as follows.

The first stage of working with the system is the creation of an AR scene and its publication, which is performed by interaction of the registered user's device with the server part of the system using a browser. To do this, any device that has a browser and access to the Internet can act as a user device, content creation devices (desktop PCs, workstations, laptops) can be used for more convenient interaction with the AR scene editor and increased efficiency of creating AR scenes.

To access the server part of the system, the user must pass authentication and authorization procedures, which ensure the safety of users' personal data, provides support for the mechanism for the collective team development of AR scenes and distribution of access rights for team members. If a user doesn't have an account in the system, one must go through a standard registration procedure. As a result of successful authorization, the user by means of the browser installed on user's device, gets access to the AR scene editor, the library of 3D models, the catalog of ready-made AR scenes, the personal catalog of AR scenes, the personal content library and the library of object recognition algorithms located on the server side (backend) of the system. It should be mentioned that access to individual recognition algorithms, 3D models and ready-made AR scenes can be regulated and differentiated with different levels of access.

A registered user can create an AR scene in two ways: create a new empty AR scene or import an existing one from the catalog of ready-made AR scenes. In the case of importing from a catalog of ready-made AR scenes, the user creates his own copy of a previously prepared scene available for editing and publishing. When creating a new scene, the user's first action is to select a recognition algorithm that ensures the positioning of the AR scene “on top” of the resulting image and the second one is to create or upload a digital twin of the recognized object.

The library of recognition algorithms contains algorithms for the localization of two-dimensional objects: images and QR codes and three-dimensional objects: faces, cylindrical objects, as well as arbitrary objects defined by 3D models.

The selected basic recognition algorithm determines both the order of the initial scene setup and its structure. Scene initialization is based on a recognizable real-world object consists in creating its digital twin, relative to which the scene will be positioned.

So, for scenes based on flat (2D) object recognition algorithms, it is proposed to upload user's own image or generate it from a natural language text description using a generative adversarial network (GANs), known from the prior art. The ability to generate images and use them as recognizable objects greatly simplifies and speeds up the creation of unique user-generated content comparing to the manual creating with image editors.

Initialization of volumetric object (3D) recognition algorithms (for arbitrary objects) involves uploading to the server side or creating digital twins of recognizable objects. For example, for cylindrical objects, the ratio of the height and radius of the base is set first, and then the texture of the side surface of the cylinder is loaded.

The basis of the AR scene is a horizontal plane, in the center of which there is a digital twin of the recognized object. The user can add to the scene:
models from the library of 3D models or his own 3D models;
own images and generated ones by text description in natural language;
videos that can be displayed both on a plane and on curved surfaces;
text messages;
sound recordings.

All user additional information used for creation of AR scenes can be stored in the user's personal content library, which provides quick access to previously used content.

The AR scene editor provides the registered user with the standard functions of a vector editor, including mutual positioning of objects in three-dimensional space, setup of colors, object and text display styles, etc.

During editing, a scene can be saved to the user's personal AR scene catalog.

The first registered user who created an AR scene and saved it in the user's personal catalog of AR scenes can provide access to it to the second, third, etc. registered users for collaboration. When co-editing a scene, objects selected and modified by different registered users can be highlighted, for example, the first scene object modified by the first registered user acquires a red translucent border, the second scene object modified by the second registered user acquires a blue border, etc. Selecting a scene object for subsequent editing makes it locked for modification by other registered users. Registered users may use third-party text, voice, or video communication tools to communicate while co-editing a scene.

In order to make the scene available for display in AR mode, a scene publishing mechanism is used over the AR scene, which provides access to it to an unlimited number of users via a URL link and a QR code (for ease of access from the user's mobile devices). In the case of a scene based on QR code recognition algorithm, it simultaneously acts as a link to the scene for the browser of the client device and as a marker for setting the AR scene.

In addition, a registered user can publish the geolocation of scenes, that is, associate the published scene with geographic coordinates, obtained from the user's current location, or by specifying a specific point on the map using Google Maps, Bing Maps and the like. Geolocation publishing allows registered users to search for nearby scenes, select a specific AR scene, and download them together with the required real-world object recognition algorithms.

In addition to publishing, the first registered user—the creator of the AR scene—can place the created AR scene in the catalog of ready-made AR scenes, providing the opportunity for other registered users to create their own scenes based on it. The first registered user can choose one of the access modes:
limited access only to a specified group of registered users;
access for all users registered in the system.

In case of limited access to the first scene, the second scene created by cloning the first one, when placed in the catalog of ready-made AR scenes, inherits the access mode of the first scene. In this case, if it is necessary to change the membership of registered users in the access group or organize unrestricted access to the second AR scene, the second registered user, being its creator, must request permission from the first registered user.

The AR scene is displayed on the user's device by an installed browser that supports WebAssembly (Wasm) virtualization technology.

Wasm technology allows to achieve the following benefits:
provide the widest range of user devices suitable for displaying the AR scene and reduce the threshold of entry due to the absence of the need to install additional software;
isolated execution of the recognition algorithm code inside the Wasm virtual machine ensures the security of user data and the stability of his device.

A registered user can search for nearby AR scenes by transmitting his current location, determined using the geolocation tools of the user's device, via the Internet to the server part of the system, which searches for published geolocations within a specified search radius and in response presents to the registered user a list of available AR scenes with descriptions and URL links and/or QR codes. Unregistered users get access to AR scenes only with the help of URL links or QR codes.

As a result of entering a URL link in the address bar of the browser of the user's device or scanning a QR code from the user's device, a request is sent via the Internet, in response to which the server part transfers to the user's device a Wasm container containing the implementation of the recognition algorithm basic for the loaded AR scene and executed in the browser directly on the user's device.

Next, the server part transfers the data of the AR scene to the user's device, after which the interaction of the client device with the server part is no longer required.

After initialization, the recognition algorithm functions autonomously, all calculations are performed directly on the user's device and no telemetry data is transmitted to the server part, which allows protecting the user's confidential data.

Images of objects that are supposed to appear over the image may be formed and stored in advance in the memory of the server data processing means or digital storage device.

Using means for forming the image signal, which in the simplest case the built-in camera that receives an image, on which an image of a recognized object could be located, the digital twin of said object downloaded from the server is stored in the memory of the image processing device. Also receiving geolocation data from the corresponding built-in geolocation module.

In case the positive recognition occurred, the user's device, using the camera's video data, determines the initial spatial position of the recognized object and places the AR scene. Scene placement is performed automatically with positioning relative to the recognized object.

If the registered user wishes to generate additional information regarding the recognized object, the additional information is entered through the information input means or obtained from any available archive, and a command is generated to transfer the additional information to the server, to associate it with the recognized object, save it to the user's personal content library and publish additional information on the server to make it accessible to other registered users.

After such publication, any registered user has the opportunity not only to view the AR scene when camera of his image processing device captures an image, on which the object is recognized but also to display the additional information representing the other registered users' emotions, impressions on experience associated with the recognized objects and its AR scenes.

A registered user has the opportunity to choose the source of additional information if there are several messages with additional information. AR scene and custom users' additional information are provided in the form of additional information displayed on the screen of the image processing device in real time by imposing over the image obtained from the output of the built-in camera, reproduced in priority order, reducing the playback volume of other concurrent applications.

The image processing apparatus comprises an image forming means, which may be a camera or digital storage device with image and/or audio data, input means, computer means, geolocation means, and a display.

Embodiments of the present invention will now be described with reference to the drawings. The arrangement of components, numerical expressions and numerical values formulated in these embodiments do not limit the scope of this invention unless specifically indicated.

The server (or augmented reality server) includes an authentication module, an AR scene editor, a library of 3D models, a catalog of ready-made AR scenes, a user's personal AR scene catalog, a user's personal content library; a library of recognition algorithms.

The image processing apparatus comprises an image forming means represented by a camera or external digital storage device with stored on it multimedia content, an input means represented by a real or onscreen keyboard and/or a microphone, calculation means implemented with a processor and software, a geolocation module, which for a global positioning system module implemented by a GPS or GLONASS modules or a module for determining location according to the GSM base stations, display and sound module, and module for communication to the server, implemented as a wireless data transmission node for wireless data transmission, within the limits of Wi-Fi standards or GPRS or LTE standards or the like. In this case, the imager forming means, input means, geolocation module and display are connected to the calculation means. The calculation means includes means for recognizing an object on the image, means for comparing geographic coordinate data, means for forming a final image for display.

From the output of the image forming means, the signal corresponding to the video image obtained with the camera or stored in the memory of an external digital storage device, enters the input of the calculation means, which provide detection and recognition of the specific object on the image obtained. In this case, the digital twin of the recognized object is extracted from the internal digital storage of the calculation tools and were received at the AR scene initialization stage from the server connected to the means of calculation via the Internet using the communication module with the server. The resulting image is displayed on the screen, which also displays the AR scene on the top of the recognized object.

If the object is recognized, and the registered user wishes to leave a comment, he makes text input using a real or on-screen keyboard and/or enters a voice comment using a microphone and/or creates a media file that associates with the recognized object and/or creates a video record using a camera and a microphone and/or adds a 3D model stored in a built-in digital storage or archive or an external digital storage device. A multimedia file can be created using software editing tools or extracted from the built-in digital storage. The user's commentary forms the additional information about the displayed AR scene.

The generated comment is associated with the recognized object in accordance with the user's command generated by the input tools and sent to the server using the communication module for communication with the server for storing in the user's personal content library. Sending comments to the server is the publication of the generated additional information. The communication module allows the user to receive comments associated with the recognized object and the AR scene from other registered users, in case such object were recognized.

Creating an AR scene can be implemented as a cyclical process that combines repetitive editing and visual verification steps on a variety of user devices (wide coverage allows for better visual quality of the scene). After editing the scene, the user—the creator of the scene—can re-publish the scene, after which the modified scene becomes available for display at the original URL link received during the first publication.

Visual verification and customization of the appearance of the AR scene on the user's device using “live” video from the camera is a time-consuming process that includes:
saving and republishing the AR scene by the first user;
launching the scene on the device of the second user;
interactive visual verification of the scene by the second user by moving the device around the marker object in such a way as to “view” the scene from all sides.

One user can act as the first and second user. One iteration of visual verification takes at least 3 minutes. The process causes rapid fatigue of the second user, who is forced to repeat essentially the same actions and evaluate the visual quality of the scene.

Improving the speed and efficiency of visual verification is achieved by shooting a recognized object once on the device of the second user and transferring the video to the first user. The first user uploads a video recording to the server part of the system, linking it to the AR scene project, after which the AR scene editor has the opportunity to “play” the scene on this video recording. Thus, the first user can perform visual verification of the AR scene directly in the AR scene editor without being distracted by interaction with the second user or display and verification on the second device.

The system allows to use several video recordings made by different devices and in different conditions (different angle, lighting), which allows one to quickly “batch” visual verification of the AR scene.

The processing algorithm for calculation means includes the following main steps.

The calculation program wrapped into a Wasm container begins when the corresponding URL link is provided to the browser address line by the user command. Next, the generated image, the geolocation data and the data from the server are retrieved, the image is extracted for recognizing the object on the image, checking the fact of object recognition, checking for the presence of additional information published by the registered users associated with the recognized object. Displaying additional information of other registered users along the AR scene. Forming and processing the additional information associated with the object for transmission of the corresponding signals to the server is the formation of a data packet for sending to the server. Checking the presence of additional information of other registered users associated with the coordinates in which the object was recognized, it is checked whether additional information was left by other registered users at a location characterized by these coordinates. At the next step, additional information from other registered users associated with the location coordinates of the user's image processing device are displayed. Command generating a signal containing additional information associated with the recognized object and AR scene and sending it to the server. In step, it is checked whether there is an exit command from the browser. If there is, then the program is finished, if not, then the next frames of the image are processed.

In view of the above, the present invention provides a system for creating and displaying AR scenes by mobile devices. The system includes a plurality of mobile devices that are used by either registered or unregistered users and provides registration capabilities for users. It allows the devices to use server-side processing for creating and editing of AR scenes.

The server capabilities are accessed from the user devices via a browser. This system includes a server part which includes an authentication module, an AR scene editor, a library of 3D models, a catalog of ready-made AR scenes, multiple personal catalogs AR scenes, associated to registered users of the system, multiple personal content libraries associated to the registered users, a library of algorithms for recognition objects and the surrounding space or environment, The system can be managed to allow access to the catalog of ready-made AR scenes to any users or only to registered users.

The client side of the system, represented by a set of user devices, each of which is equipped with a camera, a browser for displaying ready-made AR scenes and an AR scene editor, may also contain acceleration and orientation sensors.

The server part of the system can be accessed from the user's first device using a browser. The user authentication and authorization in the system provides access to users for creating and displaying AR scenes, The creation of a new scene of AR based on one of the algorithms of the library of recognition algorithms,

The user can fill the AR scene with the use of 3D model library objects and user's personal content (images, videos, text, sounds, own 3D models), stored in the user's personal content library and available for reuse. The created or amended AR scene can be saved in the user's personal catalog of AR scenes and published for display on users' devices. There is a capability of transmission of the address link and loading of the AR scene in the browser of the other user device.

The AR scene created on the first user device can be displayed in the browser of the second user device using video stream of the device's camera.

Real world objects can be recognized by various algorithms, including algorithms for recognition flat objects (images, QR codes), 3D objects (faces, cylindrical objects, arbitrary 3D objects) and similar ones from the prior art. The marker images for flat object recognition algorithms may be generated from a natural language text description.

The AR scene editor allows to:
create or upload 3D models of real world objects that will be recognized and tracked by 3D object recognition algorithms when displaying an AR scene on the user's device, for example, cylindrical objects with an arbitrary texture, arbitrary three-dimensional objects;
upload images and generate QR codes to be used as markers for positioning AR scenes by recognizing them with flat object recognition algorithms.

The access to AR scenes in the personal library can be set up as read only or it can provide editing rights for a limited circle of users registered in the system, which allows for the collective development of AR scenes by visualizing and synchronizing the actions of several users.

The recognition algorithm and AR scenes can be loaded onto the user's device during initialization, after which they function autonomously without interacting with the server side, which allows achieving a high degree of protection of confidential data and, upon completion of initialization, to function in conditions of lack of access to the Internet.

The AR scene can be displayed directly on the server side in the AR editor based on videos uploaded by the user, which allows you to quickly adjust the scene execution options to the necessary conditions and speed up their visual verification.

The creation of a new AR scene can be replaced by importing any available to a user AR scene from the catalog of AR scenes with the possibility of its subsequent editing.

In addition to publishing created or modified AR scene, it is possible to place it in the catalog of ready-made AR scenes for access by an unlimited or limited circle of users registered in the system.

### Example 1

A phone equipped with a camera, a processor with software, an integrated storage, a geolocation module, a display and a wireless communication module, for example, GPRS is used as an image processing device. A user who has subscribers to his blogs of the relevant social Internet resource, said subscribers referred to hereinafter as other registered users, while in Rome, sends a request containing its current location and search radius to the server and in response receives a list of recognized objects and their corresponding AR scenes. By selecting one of the available scenes, the user directs the camera of his device to the recognizable object corresponding to the scene, for example, to an x architectural structure (FIG. 1). The image captured by the user is processed by calculation means of the user device in order to recognize the architectural object on the image so that an architectural object that has come into view of the camera can be recognized with a certain probability as the Colosseum (according to the title of the AR scene).

The calculation means of the user's phone are used to execute the recognition algorithm, wrapped into a Wasm container using the browser virtual environment. The recognition process performs autonomously, with no data being sent to the server or other user devices to provide confidentiality.

After the object is recognized by calculation means of the phone the algorithm determines its spatial position and orientation on the image and uses it to display the AR scene on the top of the object. Beside of the recognized object can be highlighted or displayed as selected in the image by any other way.

The user registration on the server enables the user to bind additional information (comments, for instance) to the selected AR scene. Wishing to fixate the fact of visiting a known place, the registered user with the help of the input means module introduces the text with his name and forms a command for sending. In this case, the entered message is associated by calculation means of the phone with the recognized object and can be displayed on the display of the phone of another registered user, once the AR scene of the specified architectural object will be downloaded from server and the mentioned object will be received in the field of view of the phone camera and recognized.

Thus, any registered user can participate in the process of creating an augmented reality and, at the same time, has the opportunity to be in conditions of augmented reality created by other registered users due to the possibility of receiving messages with additional information from other registered users. A registered user can participate in the creation of AR scenes in two ways: by creating and publishing AR scenes using the AR scene editor or by adding information to them while viewing, reflecting impressions, emotions, mood. Unregistered users can also view AR scenes, but do not have access to additional information bound to the scene and published by registered users. These messages can be obtained by recognizing by means of calculating the telephone of objects for which messages were previously entered by other registered users.

Recognition of the object may not occur, for example, due to unsuccessful camera angle, insufficient lighting, or lack of an image of the object. In this case, the message left by the user is associated with the coordinates of the place where the user's message was made in order to report the object recognition problem to other users, in particular the scene creator, optionally by attaching the resulting images of the recognized object and/or describing the shooting conditions.

### Example 2

The method of controlling the image processing device is used to test student's knowledge within the learning course of a foreign language. A mobile communication device is used as an image processing device, said communication device comprises an embedded camera, a processor with software, a built-in a storage device, a display and audio playback means, a microphone and a wireless communication module, for example, Wi-Fi for communicating with the server.

The teacher and students together participating in the relevant educational Internet resource as registered users. The teacher instructs the students to visit after school or on the way to school known buildings in the city associated with a certain historical event and briefly characterize them in a foreign language with respect to history, importance for the city, characteristics of the owner or other, or to answer questions regarding said buildings. The teacher creates basic AR scenes using images or 3D models of historical buildings as digital twins and publishes their geolocations.

The student receives a task in the form of a map with marked locations, selects one of them, loads the corresponding AR scene in the browser and goes to the specified location.

While passing by the building, the student captures it with the built-in camera, pronounces the required text and sends it as additional information. During the process of checking out the results, the teacher uses a list of prepared scenes as scenes by viewing additional information associated with each one in turn.

For each AR scene in the task the teacher receives a list of students who have left their comments at the object they have chosen and by selecting the desired surname listens to the monologue of the corresponding student.

The task of increased complexity is to independently create an AR scene with the help of an AR scene editor for a historical building that is not included in the task of the teacher, and publish it for access by the teacher and other students in order to similarly collect answers and verification results in the form of additional information to the created scene.

Such tasks are attractive for students with their unusual character and novelty, using such tasks makes it possible to check the pupil's knowledge in the real conditions of the life of the city, and also get an idea of the dynamics of the pupil's mastery of the course when the task is repeated after a certain period of time.

The method of controlling the image processing device allows the registered user to obtain additional information on the image in real time, allowing himself to feel in the conditions of augmented reality continuously evolving due to other registered users experience. In this case, the user does not have to determine the destination for the additional information that he has generated, which is transmitted to the image processing device of any registered user when the condition of object recognition is fulfilled or, if necessary, the proximity of geographical coordinates, in which additional information was generated, that is, for an unlimited number of users.

The method for controlling the image processing device can be implemented using standard components and an set of electronic components including independent modules such as a camera, display, processor, etc.

Thus, the method of controlling the image processing apparatus is simpler in implementation by reducing the requirements for the wireless communication lines used, more convenient to use since it excludes the displaying of the additional information not related to the objects detected on the image, provides the capability of using the image in real time forming conditions of augmented reality, and also provides the opportunity to obtain additional information for an unlimited range of users.

What is claimed is:

1. A system comprising:
a server comprising an authentication module adapted to authenticate users of the plurality of devices, an editor of AR scenes, a library of 3D models, a catalog of ready-made AR scenes, personal catalogs of AR scenes associated with registered users, personal content libraries associated with registered users, and a library of recognition algorithms; and
a plurality of devices, adapted to be operated by users, said users may be registered at the server, wherein each said device comprising at least an image signal forming means, an input means, a display, a communication means, an image processing means, a browser adapted to display AR scenes, and access the editor of AR scenes at the server;
each device of the plurality of the devices is adapted to:
obtain an image by an image signal forming means and display said image signal in real time by means of a display of the device; said image is a single frame or a stream of image frames;
communicate with the server to register or authenticate a user of the device by the authentication module;-access recognition algorithms at the server and perform the image processing and recognition of an object based upon at least one recognition algorithm selected from the library of recognition algorithms,
via input means input additional information for associating with the recognized object;
create an AR scene by accessing AR scene editor at the server;
determine spatial position and orientation of the recognized object on the image and use it to display the AR scene on the top of the object;
fill the AR scene with additional data retrieved from a personal content library and the 3D library at the server;
communicate said additional information and the AR scene to the server with instruction to save it in the personal content library and the personal AR scene library at the server;
communicate an instruction to publish the AR scene and additional information at the server making it available to registered users and generate a URL link for accessing the AR scene;
communicate the URL link for the AR scene to another device of the plurality of devices;
receive the URL address from another device of the plurality of devices and display the AR scene in the browser;
wherein each registered user
has personal content library and personal AR scene catalog associated with said registered user, said registered user has exclusive access to save created AR scenes and additional information to said personal AR scene catalog and personal content library;
has access to the catalog of ready-made AR scenes at the server and can retrieve and use any available AR scene of the catalog of ready-made AR scenes for creating the AR scene;
has access to the catalog of ready-made AR scenes at the server to publish the AR scene at the ready-made AR scene catalog defining access criteria for the AR scene for other registered users;

2. The system of claim 1, wherein the library of recognition algorithms includes:
algorithms for recognition of two-dimensional object, including images and QR-codes;
algorithms for recognition three-dimensional objects using their three dimensional models;

3. The system of claim 2, wherein the AR scene editor is adapted to:
create or upload three-dimensional models of real world objects that can be recognized by the three-dimensional object recognition algorithms when display an augmented reality scene on a user's device of the plurality of the devices;
upload images and generate QR codes to be used as markers for positioning AR scenes by recognizing them with flat object recognition algorithms.

4. The system of claim 3 wherein the personal catalogs adapted to provide an access to AR scenes for editing to a limited number of registered users, allowing for collective development of AR scenes by visualizing and synchronizing the actions of multiple registered users.

5. The system of claim 4, wherein devices of the plurality of devices are adapted to load a recognition algorithm and a one or more AR scenes during initialization, and further run said recognition algorithm autonomously without interacting with the server thereby protecting confidential information of the users.

6. The system of claim 5, wherein the server is adapted to display the AR scene in the augmented reality editor based upon videos uploaded by the registered user.

7. The system of claim 1, wherein the first device is further adapted to retrieve an AR scene from the catalog of ready-made AR scenes and edit the retrieved AR scene in the browser.

8. The system of claim 1, wherein the AR scene can be saved to the catalog of ready-made AR scenes for access by all registered users or for access by a restricted number of registered users.

9. The system of claim 6 wherein marker images for flat object recognition algorithms can be generated from a natural language text description.
